(19) United States
(12) Patent Application Publication
(10) Pub. No.: US 2026/0139183 A1
(43) Pub. Date: May 21, 2026

(54) Chelating Compositions and Methods of Use

(71) Applicant: Locus Solutions IPCo, LLC, Solon, OH (US)

(72) Inventors: Lee SPEIGHT, Solon, OH (US); Daniel HAGAMAN, Mechanicsville, VA (US); Andrew MORRIS, Richmond, VA (US); Amir MAHMOUDKHANI, Solon, OH (US); Karthik N. KARATHUR, Solon, OH (US)

(21) Appl. No.: 19/118,919

(22) PCT Filed: Oct. 10, 2023
(86) PCT No.: PCT/US2023/076434

§ 371 Date: Apr. 7, 2025

Related U.S. Application Data
(60) Provisional application No. 63/414,526, filed on Oct. 9, 2022.

(51) Int. Cl. C09K 8/584; C09K 8/528

(52) U.S. Cl. CPC C09K 8/584; C09K 8/528

(57) ABSTRACT

The subject invention provides safe, environmentally-friendly compositions and efficient methods for chelating and/or descaling. More specifically, the subject invention provides compositions derived from microorganisms for the use of chelating agents in metalworking, oil and gas production, polymerization, pulp and paper production, cleaning, household cleaners and descalers, textiles, mining, pharmaceuticals, agriculture, food and beverage production, cosmetics, and water treatment, which can be used for creating useful products.

### CROSS-REFERENCE TO RELATED APPLICATION

This application claims priority to U.S. Provisional Patent Application No. 63/414,526, filed Oct. 9, 2022, which is incorporated by reference herein in its entirety.

### BACKGROUND OF THE INVENTION

Consumers utilize, and are exposed to, household, healthcare and personal care products every day. For example, most consumers' daily routine includes the use of make-up, cleansers, oral care products, medications and/or other personal care and hygiene products. Additionally, cleaning compositions are utilized daily for disinfecting surfaces, as well as removing deposits such as salts in, for example, kitchens and bathrooms. While many of these types of products contain harsh chemicals as active ingredients, additional chemicals may be included as additives that, for example, help with properties such as viscosity, foaming, corrosion prevention, and solubility of fragrances, dyes, and active components.

One specific category of chemical additives are chelating agents. Many products use chelating agents to bind to positively charged metal ions in solution, most commonly calcium and magnesium, and thereby prevent these ions from forming insoluble precipitates, e.g., scale, with other ions that may be present. These products include, for example, pharmaceuticals, cleaners, descalers, laundry detergents, foods and cosmetics, Additionally, many industrial processes such as, e.g., metal finishing, mining operations, food and beverage preparation, paper and pulp production, textile production, and oil and gas production and refining, use synthetic chelating agents to sequester metals that can interfere with the various production processes.

For example, systematic inhibition or removal of scale deposits is crucial to maintaining properly functioning oil and gas producing facilities. Once even a thin layer of a deposit forms on a surface, such as in a formation pore throat, the rate of further accumulation drastically increases. Furthermore, as an oil well ages, deposits become more prevalent due to changes in the environment within the formation and the well. For example, as reservoir pressure drops, oil production decreases, which in turn decreases flow rates. The slowing of flow rates can lead to the buildup of deposits in the pores of the formation, thus reducing hydrocarbon movement into the wellbore. This can lead to changes in temperature gradients and thus even greater precipitation of deposits, including scale. Thus, the effects are interrelated, cyclical and compounding, unless they are dealt with consistently.

Iron and zinc sulfide scales have been found in several fields in onshore and offshore oil and gas wells and are often associated with formations containing native sulfide deposits and sour reservoir fluids. Scale deposition can cause significant pressure and rate reductions in high-temperature and high-rate gas, condensate, and black oil wells. Metal oxides and carbonate are also commonly found alongside sulfides, causing them to be the most challenging scales to inhibit and/or remove.

In household and other industrial environments, insoluble precipitates can form what is called hard water scale, and water containing ions such as calcium and magnesium is referred to as hard water. Hard water can be softened by removing the calcium and magnesium ions with a water softener, which exchanges sodium ions for the calcium and magnesium ions in solution. Alternatively, cleaning products can be formulated with chelators, which the ions in solution to prevent the formation of deposits.

Calcium and magnesium ions also form insoluble precipitates with many anionic surfactants, most notably fatty acid carboxylates (soap). Essentially all calcium must be removed from the solution for there to be enough free surfactant available for cleaning; otherwise, more surfactant must be utilized. Further, the insoluble calcium soap complex would precipitate from solution onto the surface to be cleaned, which can produce a dull appearance and/or a stiff feel on washed textiles. Thus, chelators used for these purposes are sometimes referred to as “builders,” as they help build upon the performance of the surfactant.

Chelating agents are also effective in removing some stains, such as those caused by high calcium-content materials, like cheese. Stains are complex molecular structures, and may contain metal ions cross linking and stabilizing the stain structure. Thus, chelators in cleaning solutions can bind with these metal ions, weakening the stain structure and facilitating its removal.

Beyond calcium and magnesium, chelants bind with all polyvalent metal ions in solution. Iron and manganese can also lead to significant cleaning problems, including the formation of insoluble precipitates such as iron oxide, rust, and manganese dioxide. Therefore, specialty cleaners are often formulated with highly efficient iron chelators to bind with these ions, which can prevent and/or help remove rust and iron stains.

Chelating agents are also used to improve the shelf-life of hydrogen peroxide, prevent the decomposition of bleaches, help prevent allergies to nickel or chromium, and aid in the coloring of cleaning products.

Despite their many uses, however, chelating agents are associated with various risks. The common chelator ethylenediaminetetraacetic acid (EDTA) is not readily biodegradable, particularly once complexed with metal ions. This may lead to environmental accumulation, which could cause toxicity to plants and animals. Phosphonates, another type of chelating agent, are associated with cancer, and accumulate in water sources, which can result in eutrophication.

Safer alternatives are known, such as citric acid; however, this readily biodegradable ingredient is not as effective as EDTA and is not compatible with certain cleaning products due to its characterization as a weak acid. Thus, there is a need for improved compositions and methods for chelating metals and minerals that are safer for consumers and for the environment.

### BRIEF SUMMARY OF THE INVENTION

The subject invention provides advantageous chelating products that contain one or more biosurfactants. The subject invention also provides methods of using these chelating products. Advantageously, the chelating products and methods of the subject invention replace or reduce the use of conventional chemical chelating agents and descaling agents. Thus, the subject invention is environmentally-friendly, operational-friendly and cost-effective when compared to conventional chelating and descaling treatments.

The subject invention relates generally to the use of chelating agents in a variety of industries, products, and activities, including, for example, metalworking, oil and gas production, polymerization, pulp and paper production, cleaning, household, industrial and institutional (HI&I) cleaners and descalers, textiles, mining, pharmaceuticals, agriculture, food and beverage production, cosmetics, and water treatment. More specifically, the subject invention provides environmentally-friendly compositions and methods for sequestering and/or dissolving metals, minerals, or elements, such as, for example, calcium, magnesium, iron, copper, nickel, gold, silver, molybdenum, aluminum, lead, tungsten, chromium, cadmium, zinc and arsenic, from various solutions or surfaces. In certain specific embodiments, the compositions and methods can be used for scale removal and/or scale inhibition.

In one embodiment, the subject invention provides chelating products, as well as their use in enhancing the performance of HI&I cleaning formulations, descalers, pharmaceuticals, cosmetics, oil well treatments and other formulations described herein by dissolving and/or sequestering harmful, contaminating and/or otherwise undesirable components, such as, for example, metals, minerals, and elements, from liquids.

In one embodiment, the subject invention provides chelating products, as well as their use in enhancing the efficiency of HI&I cleaning and descaling, metalworking, oil and gas production, polymerization, pulp and paper production, textile production, mining, agriculture, food and beverage production, and water treatment by dissolving and/or sequestering harmful, contaminating and/or otherwise undesirable components, such as, for example, metals, minerals, and elements, from equipment or liquids.

In certain embodiments, the subject invention provides chelating compositions comprising components that are derived from microorganisms. In certain embodiments, the composition comprises a microbial biosurfactant. The biosurfactant can be utilized in crude form, which can comprise, in addition to the biosurfactant, fermentation broth in which a biosurfactant-producing microorganism was cultivated, residual microbial cell material or live or inactive microbial cells, residual nutrients, and/or other microbial growth by-products.

In some embodiments, the biosurfactant is utilized after being extracted and/or isolated from a fermentation broth and, optionally, purified. In some embodiments, the biosurfactant is subjected to further chemical derivatization.

The biosurfactant according to the subject invention can be a glycolipid (e.g., sophorolipid, rhamnolipids, cellobiose lipid, mannosylerythritol lipid and trehalose lipid), lipopeptide (e.g., surfactin, iturin, fengycin, arthrofactin, and lichenysin), flavolipid, phospholipid (e.g., cardiolipin), fatty acid ester compound, fatty acid ether compound, and/or high molecular weight polymer, such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically.

The chelating composition according to the subject invention preferably comprises a biosurfactant, and, optionally comprises other compounds, such as, for example, synthetic chelating agents, naturally-derived chelating agents, chemical surfactants, essential oils, botanical extracts, cross-linking agents, fatty acids, alcohols, pH adjusting agents, reducing agents, builders, syndetics, buffers, enzymes, dyes, colorants, fragrances, preservatives, emulsifiers, foaming agents, polymers, thickeners and/or viscosity modifiers. The additives are dependent upon the particular formulation and use thereof.

In an exemplary embodiment, the chelating composition comprises a sophorolipid and a chelating agent, such as EDTA or disodium EDTA.

In certain embodiments, the biosurfactants according to the present invention can serve as active chelating ingredients in environmentally-friendly cleaning compositions, such as, for example, dishwasher (auto-dish) detergents, laundry detergents, and bathroom and kitchen surface cleaners. Advantageously, the chelating compositions comprising the biosurfactant(s) can help with, for example, preventing water spots on dishes, lifting stains, dissolving food particles, and disrupting biofilms, among other uses. In certain embodiments, the biosurfactants serve as enhancers for traditional chelating and/or descaling compounds.

In certain embodiments, the subject invention provides a method for sequestering and/or dissolving metals, minerals, or elements in a liquid, wherein the method comprises contacting a chelating composition according to the subject invention with a liquid for a period of time to yield a mixture comprising a treated liquid.

In some embodiments, the contacting step comprises applying a chelating composition comprising a biosurfactant and, optionally, other components, such as, for example, chemical chelating agents, naturally-derived chelating agents, and/or chemical surfactants to a liquid or a solid surface. The contacting step can be repeated as many times as necessary to achieve a desired amount of sequestration or dissolution of metals, minerals, or elements.

In some embodiments, the method enhances or increases the rate of sequestration and/or dissolution and/or the total amount of sequestered or dissolved metals, minerals, or elements when compared with application of a traditional chelating agent alone. In certain embodiments, the composition according to the subject invention is effective due to enhancing and/or increasing the rate of sequestering of metals into a stable complex with the subject chelating composition. For example, in some embodiments, a sophorolipid will form a complex containing the metals. In some embodiments, the complex is less than 500 μm, less than 100 μm, less than 10 μm, less than 1 μm, less than 100 nm, less than 50 nm, less than 25 nm, less than 15 nm or less than 10 nm in size.

In certain embodiments, the methods of the subject invention result in at least a 25% increase in the rate of sequestering of metals, preferably at least a 50% increase, after one treatment, compared with a traditional chelating agent alone. In certain embodiments, the liquid or surface can be treated multiple times to further increase the amount of sequestered metals or rate of sequestering of metals.

In one embodiment, the subject invention provides an improved laundry formulation comprising a chelating composition of the subject invention. In one embodiment, the subject invention provides an improved dish cleaner comprising a chelating composition of the subject invention. The compositions can be formulated for reduced skin and eye sensitivity for users.

In one embodiment, the subject invention provides improved descaling compositions for removing and/or preventing scale deposition on surfaces, such as in oil and gas environments and in laundry and dishwashing machines.

Advantageously, in certain embodiments, the composition according to the subject invention can be effective at minimizing buildup of contaminants during, for example, household cleaning and industrial processes, and avoids and/or reduces the use of toxic chelating compounds. Furthermore, the methods of the subject invention do not require complicated equipment or high energy consumption, and production of the composition can be performed on site, for example, at an industrial site.

### DETAILED DESCRIPTION

The subject invention relates generally to the dissolution of metals, minerals, or elements and/or sequestration of metals, minerals, or elements into an inert complex. More specifically, the subject invention provides environmentally-friendly compositions and methods for sequestering metals, minerals, or elements, such as, for example, calcium, magnesium, iron, copper, nickel, gold, silver, molybdenum, aluminum, lead, tungsten, chromium, cadmium, zinc, or arsenic. Accordingly, the subject invention is useful for improving the efficiency of sequestering and/or dissolving metals, minerals, or elements, as well as for inhibiting and/or removing scale deposits. Further provided are improved laundry, dish, and other formulations comprising the chelating compositions, as well as methods of their use.

### Selected Definitions

As used herein, “applying” a composition or product refers to contacting it with a target or site such that the composition or product can have an effect on that target or site. The effect can be due to, for example, the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, a “chelation” refers to the formation of two or more coordinate bonds between a ligand and a single metal atom.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

As used herein, “scale” is a deposit caused by the precipitation and accumulation of crystals that occurs when a fluid becomes saturated with ionic species that form micro-aggregates. Scale can be organic, such as paraffin wax, asphaltene and/or gas hydrates; as well as inorganic, which include mineral deposits resulting from the precipitation of, for example, barium sulfate, calcium carbonate, calcium sulfate, calcium oxalate, magnesium hydroxide, magnesium oxide, silicates, strontium sulfate, aluminum oxide hydroxides, aluminosilicates, magnetite or nickel ferrite, sodium chloride, silicon dioxide, iron sulfide, iron oxides, iron carbonate, copper, phosphates, and oxides. In certain specific embodiments, the scale is a metal sulfide scale, such as iron sulfide or zinc sulfide.

As used herein, “prevention” means avoiding, delaying, forestalling, inhibiting or minimizing the onset or progression of an occurrence or situation. Prevention can include, but does not require, absolute or complete prevention, meaning the occurrence or situation may still develop at a later time and/or with a lesser severity than it would without preventative measures. Prevention can include reducing the severity of the onset of an occurrence or situation, and/or inhibiting the progression thereof to one that is more severe. A scale “inhibitor” is an agent that prevents the precipitation of scale from a fluid and/or accumulation thereof onto surfaces.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between phases. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to form pores and destabilize biological membranes also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

“Sophorolipids” are glycolipid biosurfactants produced by, for example, various yeasts of the Starmerella clade. SLP consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid can have, for example, 11 to 20 carbon atoms, and may contain one or more unsaturated bonds. Furthermore, the sophorose residue can be acetylated on the 6- and/or 6′-position(s). The fatty acid carboxyl group can be free (acidic or linear form) or internally esterified at the 4″-position (lactonic form). In most cases, fermentation of SLP results in a mixture of hydrophobic (water-insoluble) SLP, including, e.g., lactonic SLP, mono-acetylated linear SLP and di-acetylated linear SLP, and hydrophilic (water-soluble) SLP, including, e.g., non-acetylated linear SLP.

As used herein, the term “sophorolipid,” “sophorolipid molecule,” “SLP” or “SLP molecule” includes all forms, and isomers thereof, of SLP molecules, including, for example, acidic (linear) SLP and lactonic SLP. Further included are mono-acetylated SLP, di-acetylated SLP, esterified SLP, SLP with varying hydrophobic chain lengths, SLP with fatty acid-amino acid complexes attached, and other, including those that are and/or are not described within in this disclosure.

SLP can be represented by General Formula (A) and/or General Formula (B), and are obtained as a collection of multiple structural homologues:

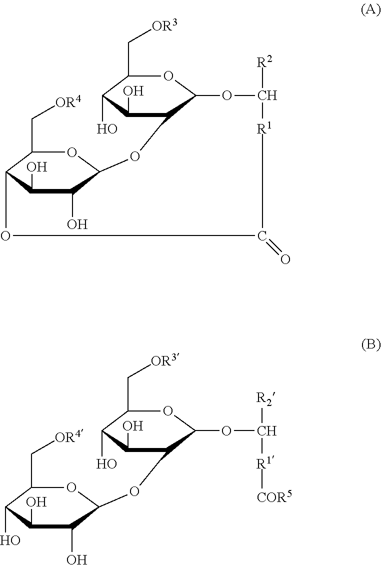

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃. R⁵ is typically an H.

Due to the structure and composition of SLP, these biosurfactants have excellent surface and interfacial tension reduction properties, as well as other beneficial biochemical properties, which can be useful in applications such as large scale industrial and agriculture uses, cosmetics, household products, health, medical and pharmaceutical fields, and oil and gas recovery.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Chelating Compositions

In certain embodiments, the subject invention provides chelating compositions comprising components that are derived from microorganisms. In certain embodiments, the chelating composition comprises a microbial biosurfactant. In certain embodiments, the composition comprises a biosurfactant, and, optionally, synthetic chelating agents, natural chelating agents, chemical surfactants, or any combination thereof.

In certain embodiments, the chelating composition comprises a biosurfactant. The biosurfactant can be utilized in crude form, which can comprise, in addition to the biosurfactant, fermentation broth in which a biosurfactant-producing microorganism was cultivated, residual microbial cell material or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted and/or isolated from a fermentation broth and, optionally, purified. In some embodiments, the biosurfactant is subjected to further chemical derivatization.

In certain embodiments, the biosurfactants according to the present invention can serve as active chelating ingredients in environmentally-friendly formulations for use in personal care, household and industrial uses. In certain embodiments, the biosurfactants serve as enhancers for traditional chelating compounds utilized in these formulations.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically.

In certain embodiments, the subject invention provides modified sophorolipids having chelating properties and/or chelation-enhancing properties. The compounds can have a structure according to, for example, General Formulas (I)-(IV):

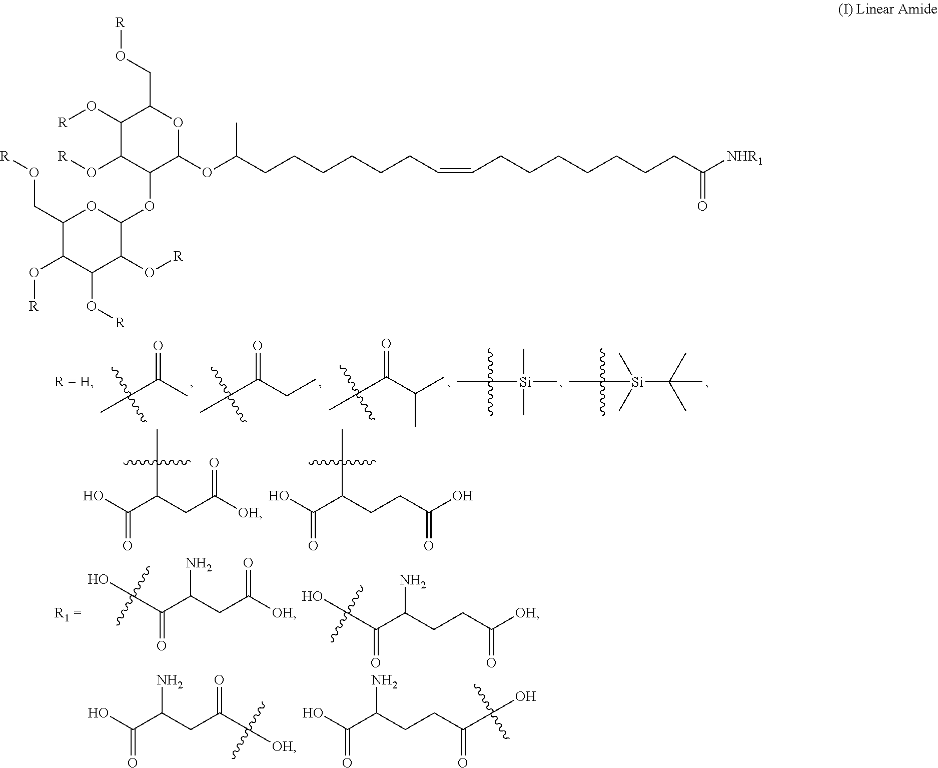

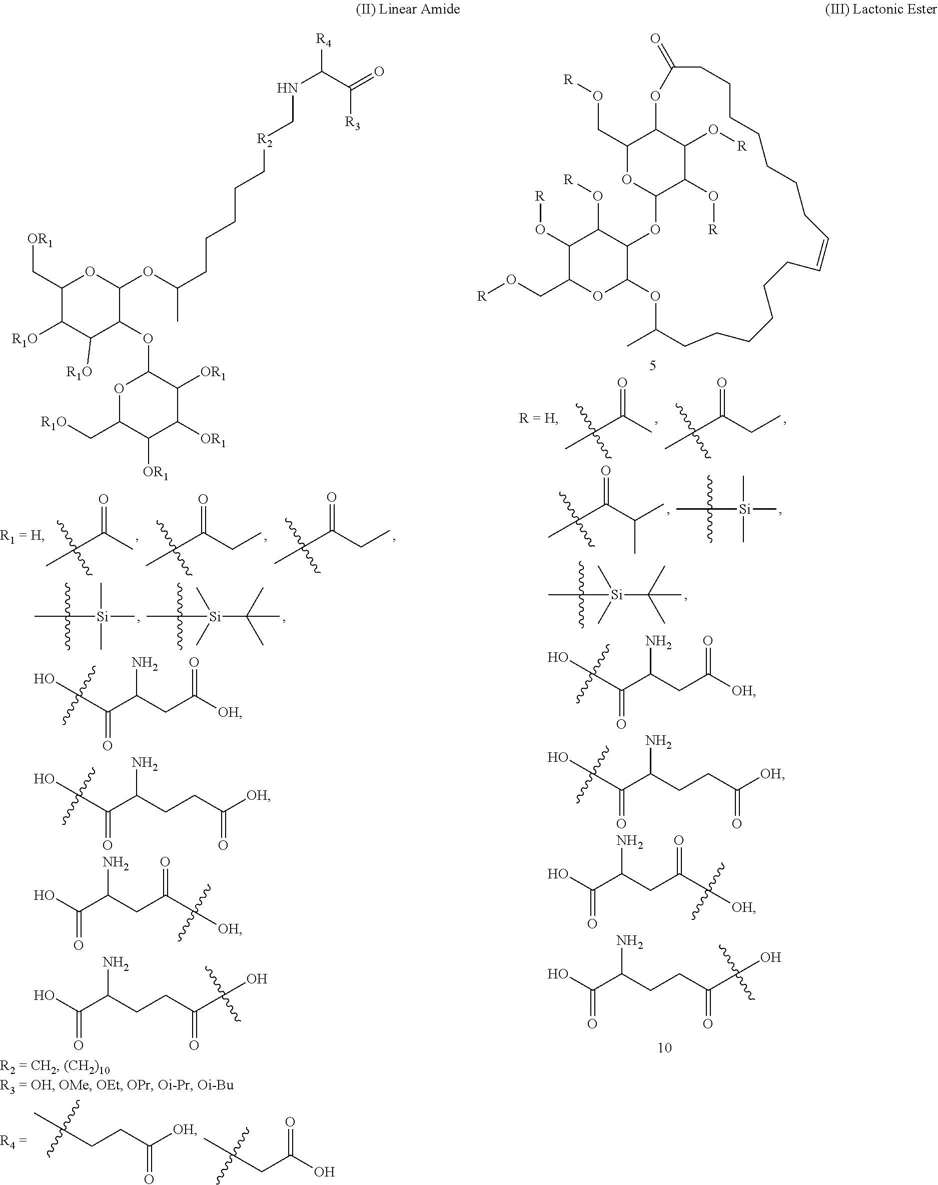

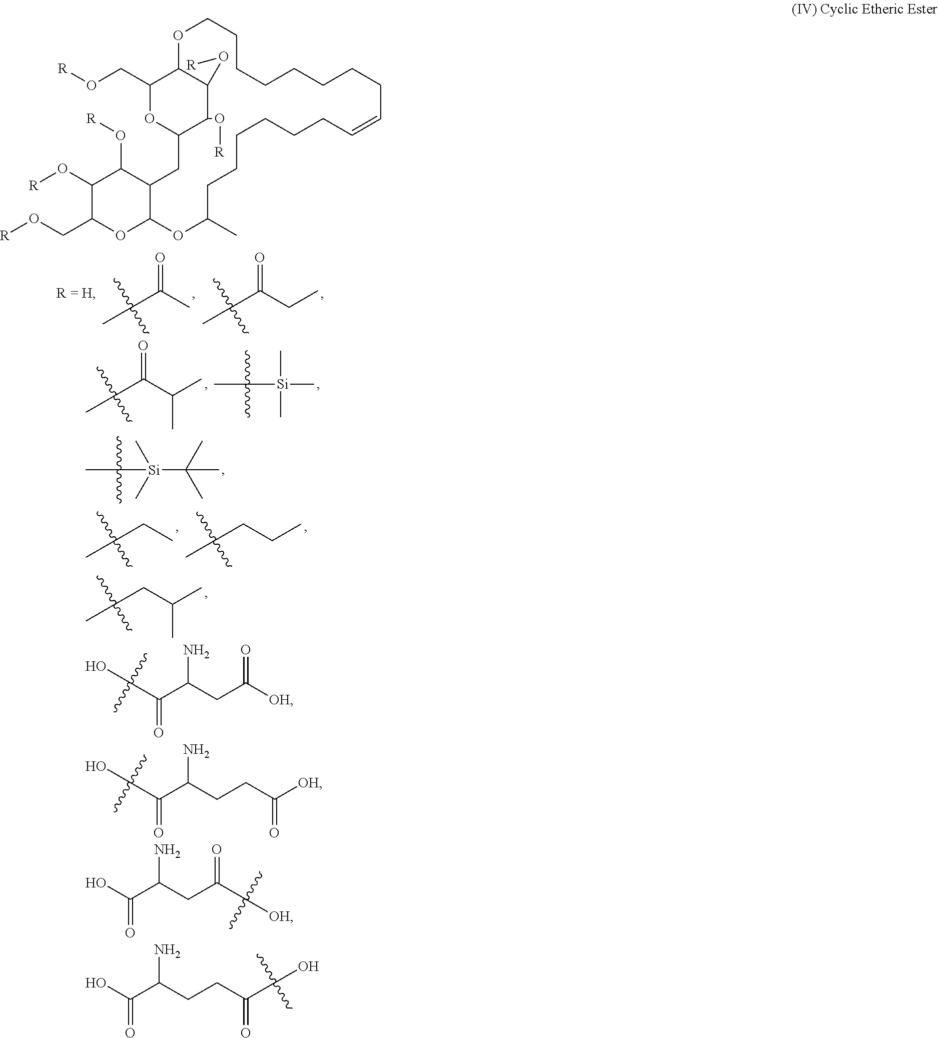

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total chelating composition.

In another embodiment, purified biosurfactants may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

The chelating composition according to the subject invention preferably comprises a biosurfactant, and, optionally comprises other additives, such as, for example, synthetic chelating agents, naturally-derived chelating agents, chemical surfactants, essential oils, botanical extracts, cross-linking agents, fatty acids, alcohols, pH adjusting agents, reducing agents, builders, syndetics, buffers, enzymes, catalysts, solvents, buffers, salts, acids, dyes, colorants, fragrances, preservatives, emulsifiers, lubricants, stabilizers, UV light resistant agents, foaming agents, polymers, biocides, thickeners and/or viscosity modifiers and other ingredients specific for an intended use.

The additives can be included in the composition at, for example, 0.001 to 99.9%, 0.01 to 90%, 0.05 to 80%, 0.1 to 70%, 1.0 to 50%, 1.5 to 25%, or 2.0 to 15% by weight, with respect to the total chelating composition.

In certain embodiments, synthetic chelating agents can be, but are not limited to, EDTA, nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3O10), trisodium phosphate (TSP) or any combination thereof.

In certain embodiments, naturally-derived and/or biodegradable chelating agents can be, but are not limited to, water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na₄, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

In some embodiments, the synthetic and/or natural/biodegradable chelating agent can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total chelating composition.

In an exemplary embodiment, the chelating composition comprises a sophorolipid and a chelating agent, such as EDTA or disodium EDTA.

In some embodiments, the chelating composition further comprises a chemical or non-biological surfactant. Surfactants are surface active agents having two functional groups, namely a hydrophilic (water-soluble) or polar group and a hydrophobic (oil-soluble) or non-polar group. The hydrophobic group is usually a long hydrocarbon chain (C8-C18), which may or may not be branched, while the hydrophilic group is formed by moieties such as, e.g., carboxylates, sulfates, sulfonates (anionic), alcohols, polyoxyethylenated chains (nonionic) and quaternary ammonium salts (cationic).

Non-biological surfactants according to the subject compositions and methods include, but are not limited to: ethoxylated nonyl phenol phosphate esters, alkyl glucoside, alkyl phosphonium chloride, alkyl phosphonate surfactants, linear alcohols, nonylphenol compounds, quaternary amine, alkyoxylated fatty acids, alkylphenol alkoxylates, ethoxylated amides, methyl ester sulfonates, hydrolyzed keratin, sulfosuccinates, taurates, trimethyltallowammonium chloride, trimethylcocoammonium chloride, quaternary alkyl ammonium chloride, propargyl alcohol, acetylenic alcohol, phosphate esters, imidazolines, amine salts, amide salts, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, sulfonated olefins, anionic surfactants, ammonium lauryl sulfate, sodium lauryl sulfate (also called SDS, sodium dodecyl sulfate), alkyl-ether sulfates sodium laureth sulfate (also known as sodium lauryl ether sulfate (SLES)), sodium myreth sulfate; docusates, dioctyl sodium sulfosuccinate, perfluorooetanesulfonate (PFOS), perfluorobutanesulfonate, linear alkylbenzene sulfonates (LABs), alkyl-aryl ether phosphates, alkyl ether phosphate; carboxylates, alkyl carboxylates (soaps), sodium stearate, sodium lauroyl sarcosinate, carboxylate-based fluorosurfactants, perfluorononanoate, perfluorooctanoate; cationic surfactants, pH-dependent primary, secondary, or tertiary amines, octenidine dihydrochloride, permanently charged quaternary ammonium cations, alkyltrimethylammonium salts, cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldi-methylammonium bromide (DODAB); zwitterionic (amphoteric) surfactants, sultaines CHAPS (3-[(3-Cholamidopropyl)dimethylammonio]-1-propanesulfonate), cocamidopropyl hydroxysultaine, betaines, cocamidopropyl betaine, phosphatidylserine, phosphatidylethanolamine, phosphatidylcholine, sphingomyelins; nonionic surfactants, ethoxylate, long chain alcohols, fatty alcohols, cetyl alcohol, stearyl alcohol, cetostearyl alcohol, oleyl alcohol, polyoxyethylene glycol alkyl ethers (Brij): CH3-(CH2)10-16-(O-C2H4)1-25-OH (octaethylene glycol monododecyl ether, pentaethylene glycol monododecyl ether), polyoxypropylene glycol alkyl ethers: CH3-(CH2)10-16-(O-C3H6)1-25-OH, glucoside alkyl ethers: CH3-(CH2)10-16-(O-Glucoside)1-3-OH (decyl glucoside, lauryl glucoside, octyl glucoside), polyoxyethylene glycol octylphenol ethers: C8H17-(C6H4)-(O-C2H4)1-25-OH (Triton X-100), polyoxyethylene glycol alkylphenol ethers: C9H19-(C6H4)-(O-C2H4)1-25-OH (nonoxynol-9), glycerol alkyl esters (glyceryl laurate), polyoxyethylene glycol sorbitan alkyl esters (polysorbate), sorbitan alkyl esters (spans), cocamide MEA, cocamide DEA, dodecyldimethylamine oxide, copolymers of polyethylene glycol and polypropylene glycol (poloxamers), and polyethoxylated tallow amine (POEA).

Anionic surfactants contain anionic functional groups at their head, such as sulfate, sulfonate, phosphate, and carboxylates. Prominent alkyl sulfates include ammonium lauryl sulfate, sodium lauryl sulfate (also called SDS, sodium dodecyl sulfate) and the related alkyl-ether sulfates sodium laureth sulfate, also known as sodium lauryl ether sulfate (SLES), and sodium myreth sulfate. Carboxylates are the most common surfactants and comprise the alkyl carboxylates (soaps), such as sodium stearate.

Surfactants with cationic head groups include: pH-dependent primary, secondary, or tertiary amines; octenidine dihydrochloride; permanently charged quaternary ammonium cations such as alkyltrimethylammonium salts: cetyl trimethylammonium bromide (CTAB) a.k.a. hexadecyl trimethyl ammonium bromide, cetyl trimethylammonium chloride (CTAC); cetylpyridinium chloride (CPC); benzalkonium chloride (BAC); benzethonium chloride (BZT); 5-Bromo-5-nitro-1,3-dioxane; dimethyldioctadecylammonium chloride; cetrimonium bromide; and dioctadecyldi-methylammonium bromide (DODAB).

Zwitterionic (amphoteric) surfactants have both cationic and anionic centers attached to the same molecule. The cationic part is based on primary, secondary, or tertiary amines or quaternary ammonium cations. The anionic part can be more variable and include sulfonates. Zwitterionic surfactants commonly have a phosphate anion with an amine or ammonium, such as is found in the phospholipids phosphatidylserine, phosphatidylethanolamine, phosphatidylcholine, and sphingomyelins.

A surfactant with a non-charged hydrophilic part, e.g., ethoxylate, is non-ionic. Many long chain alcohols exhibit some surfactant properties.

In certain embodiments, the chemical or non-biological surfactant of the chelating composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total chelating composition.

### Household Formulations

In certain embodiments, the biosurfactants according to the present invention can serve as active chelating ingredients in environmentally-friendly cleaning compositions, such as, for example, dishwasher (auto-dish) detergents, laundry detergents, and bathroom and kitchen surface cleaners. Advantageously, the chelating compositions comprising the biosurfactant(s) can help with, for example, preventing and/or removing water spots and soap scum, lifting stains, dissolving food particles, and disrupting biofilms, among other uses. In certain embodiments, the biosurfactants serve as enhancers for traditional chelating compounds.

In some embodiments, the chelating composition can be formulated into a cleaning composition, wherein the cleaning composition can comprise additional surfactants, for example, alkyl polyglucoside surfactants. Examples of alkyl polyglucosides for use herein include alkylpolyglucosides having a hydrophobic group containing from about 6 to about 30 carbon atoms, or from about 10 to about 16 carbon atoms, and polysaccharide units.

Commercially available preferred alkylglycosides include, but are not limited to, Glucopon 425@(a C₈-C₁₆alkyl polyglycoside available from Cognis Corporation), Glucopon 625@(a C₁₂-C₁₆alkyl polyglycoside available from Cognis Corporation), Dow Triton® CG-110 (a C₈-C₁₀alkyl polyglycoside available from Dow Chemical Company), AG6202@(a C₈ alkyl polyglycoside available from Akzo Nobel) and Alkadet 35® (a C₈-C₁₀ alkyl polyglycoside available from Huntsman Corporation). A C8 to C10 alkylpolyglucoside (e.g., caprylyl/capryl glucosides) includes alkylpolyglucosides wherein the alkyl group is substantially C8 alkyl, substantially C10 alkyl, or a mixture of substantially C8 and C10 alkyl. A C6 to C8 alkylpolyglucoside includes alkylpolyglucosides wherein the alkyl group is substantially C6 alkyl, substantially C8 alkyl, or a mixture of substantially C6 and C8 alkyl. In another embodiment, a C6 alkylpolyglucoside can be used in the present invention. An exemplary embodiment of a C6 alkylpolyglucoside is AG 6206@(a C₆ alkyl polyglycoside available from Akzo Nobel).

In one embodiment, the composition comprises one or more of: caprylyl/capryl glucoside, lauryl glucoside, decyl glucoside and/or myristyl glucoside.

In certain embodiments, the cleaning composition can contain a fatty alcohol sulfate as an additional surfactant. The fatty alcohol sulfate is one in which the higher alcohol or alkyl group is normally in the range of 10 to 18 carbon atoms. The cation can include sodium, triethanolamine, potassium, ammonium, magnesium and/or calcium.

Preferred fatty alcohol sulfates are those wherein the fatty alcohol is essentially saturated and has a carbon content of 10 to 18 carbon atoms, preferably 10 or 12 to 14 or 16 carbon atoms, such as 12 to 16, or that is derived from coconut oil (coco), palm oil, or palm kernel oil. Lauryl sulfates, and particularly, sodium lauryl sulfate, are preferred primary detergents but such designation also may apply to such detergents wherein the carbon chain length of the alcohol is not limited to 12 carbon atoms, but is primarily (over 50% and nonnally over 70 or 75%) of 12 to 14 carbon atoms. Such materials may be obtained from natural sources, such as coconut oil and palm kernel oil.

In one embodiment, the fatty alcohol sulfate is a C12-C18 fatty alcohol sulfate. In another embodiment, the fatty alcohol sulfate is a C12-C16 fatty alcohol sulfate. In another embodiment, the fatty alcohol sulfate is a C12-C14 fatty alcohol sulfate. In another embodiment, the fatty alcohol is a C12 fatty alcohol sulfate. In another embodiment, the fatty alcohol sulfate is sodium lauryl sulfate.

In certain embodiments, the cleaning composition comprises an amine oxide-based surfactant, such as, for example, layrtidimethylamine oxide (LDAO), dodecyldimethylamine oxide (DDA)), lauramine oxide and/or myristamine oxide.

In certain embodiments, if enhanced detergency and/or foaming is desired and/or required, hydrophilic and/or hydrophobic syndetics can be beneficial in delivering formulations that can decrease the interfacial tension between an aqueous solution and oily substances commonly encountered as “soils” on materials and/or surfaces.

In one embodiment, the cleaning composition can comprise a hydrophilic syndetic, which can rapidly adsorb at the interface between a water-immiscible oil and water, together with the surfactant(s), resulting in very low interfacial tension values. The short-chain hydrophilic syndetic can be a C₆ alkyl polyglucoside, a C₆ to C₈ alkyl polyglucoside, or a C₈ alkyl polyglucoside. Alternative suitable hydrophilic syndetics are C₆ alkyl sulfate or C₆ to C₈ alkyl sulfate. Another alternative suitable hydrophilic syndetic is a C₄ to C₈ alkyl polypentoside, an example of which is Radia® Easysurf 6505. The alkyl polypentosides are materials of desirably high RCI in which the hydrophilic groups are derived from raw material sources such as wheat bran and straw. Such biomass-based sources, when refined, yield syrups that are enriched in pentoses, or 5 carbon sugars, such as arabinose and xylose. Glycosylation of pentoses with alcohols is readily accomplished, adding the hydrophobic alkyl groups, which provide the resulting materials with interfacial activity.

Preferably, the alkyl chains are derived from fatty alcohols which are derived from a natural source, such as coconut or palm oil, or sugar beets, or distilled cuts of fatty alcohols from such plant-based raw materials. Condensation reactions between the hydrophilic pentoses may occur during synthesis of the interfacially active materials, thus producing practical final materials that can be described as alkyl polypentosides. Herein, glycosylated pentoses and their mixtures are referred to as alkyl pentosides, alkyl xylosides or alkyl polypentosides. In order for these materials to function as hydrophilic syndetics, the alkyl chains should be relatively short, that is the average length of the chain should be from about 4 to 8 carbon atoms.

In certain embodiments, the cleaning composition comprises a hydrophobic syndetic, which can interact with the other components, including oils and surfactants. The incorporation of both hydrophilic and hydrophobic syndetics in formulations can help achieve rapid reduction of interfacial tension. As is well known in the art, the removal of oily substances from surfaces by cleaning formulations proceeds via either the so-called “roll-up” of oil, or “snap-off” of oil, or true “solubilization” of oil. The efficiency of all of these processes is improved by the reduction of interfacial tension.

In certain embodiments, the cleaning compositions can include one or more solvents, including but not limited to water, alcohols, plant derived alcohols, glycols, mineral spirits, alkylaromatics, terpenoids, terpenoid derivatives, terpenes, and terpenes derivatives and/or vegetable oils. Water insoluble solvents can be mixed with a water-soluble solvent when employed.

In certain embodiments, the cleaning compositions can comprise one or more solvents such as, for example, ethanol, methanol, n-propanol, isopropyl alcohol, 2-methyl-2-propanol, hexanol, isopropanol, sorbitol, 1,3-propanediol, glycerine, octoxyglycerin, glycerol, propylene glycol, diglycerol, dipropylene glycol, phenoxyethanol, benzyl alcohol or its derivatives (e.g., hydroxylbenzyl alcohol, nitro benzyl alcohol, or other derivatives), 1-phenoxy-2-propanol, phenethyl alcohol, isopropyl myristate, denatured alcohol (SDA 40B and SDA 3C), pinene, limonene, d-limonene, and/or mixtures thereof.

In certain embodiments, the solvents are used at amounts ranging from about 0.001% to about 25% by weight with respect to the total cleaning composition, about 0.01% to about 30%, about 0.05% to about 35%, about 0.1% to about 40%, about 0.5% to about 45%, about 0.75% to about 50%, about 1.0% to about 55%, about 1.5% to about 60%, about 2.0% to about 65%, about 3.0% to about 70%, about 4.0% to about 75%, about 5.0% to about 80%, about 6.0% to about 85%, about 7.0% to about 90%, or about 10% to about 99%.

When the composition is an aqueous composition, water can be, along with the solvent, a predominant ingredient. The water should be present at a level of less than 99.9%, more preferably less than about 99%, and most preferably, less than about 98%. Deionized water is preferred. Where the cleaning composition is concentrated, the water may be present in the composition at a concentration of less than about 85% by weight.

In some embodiments, the cleaning composition comprises a builder, which can help increase the effectiveness of surfactants. Builders can include, for example, a softener, a sequestering agent, a chelator, a buffering agent, an emulsifier, and/or a pH adjusting agent.

A variety of builders can be used, including, but not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxy-sulfonates, and starch derivatives. Builders, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2-methylpropanol. Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Mixtures of any of the above are also acceptable.

Other useful inorganic buffers/alkalinity sources that can serve as builders include ammonia, alkali metal carbonate, alkali metal bicarbonate, alkali metal phosphates, alkali metal hydroxide, alkali metal silicate and combinations thereof. These builders are often obtained from natural sources. The term silicate is meant to encompass silicate, metasilicate, polysilicate, aluminosilicate and similar compounds.

In one embodiment, the buffer/builder is sodium silicate, sodium carbonate, sodium polyphosphate, or potassium carbonate. In certain embodiments, the composition contains essentially no phosphates.

In some embodiments, the builder can be a sequestrant, which can hold, or sequester, metal ions in solution. Sequestrants can be useful in the presence of hard water, which contains calcium and magnesium ions that bind to anionic surfactants and reduce the efficacy of a detergent.

A variety of sequestrant builders can be used, including, but not limited to, ammonium and substituted ammonium polyacetates, trialkali salts of nitrilotriacetic acid, carboxylates, polycarboxylates, polyphosphates, aminopolycarboxylates, polyhydroxy-sulfonates, and starch derivatives. Specific examples include, but are not limited to, carbamate, phosphate, polyphosphate, pyrophosphates, triphosphates, tetraphosphates, ammonia, monoethanolamine, monopropanolamine, diethanolamine, dipropanolamine, triethanolamine, and 2-amino-2-methylpropanol.

Some further sequestrants are nitrogen-containing materials, such as, for example, amino acids such as lysine or lower alcohol amines like mono-, di-, and tri-ethanolamine. Other preferred nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Mixtures of any of the above are also acceptable.

In one embodiment, a rhamnolipid biosurfactant can, in addition to and/or as an alternative to being used as a detersive surfactant, serve as a water softener and/or sequestrant by binding metals, such as calcium and magnesium, which are present in hard water.

In certain embodiments, the builder is a pH adjuster. In some embodiments, the pH is adjusted to about 0.5 to 5.0 for use in, for example, toilet bowl and/or drain cleaners, where the removal of deposits such as limescale, rust or other mineral deposits is needed. In some embodiments, the pH is adjusted to about 5.0 to about 8.0 for use in, for example, hand soaps, dish liquids, and all-purpose surface cleaners, where more neutral pH is needed to avoid corrosion of surfaces and/or skin irritation. In some embodiments, the pH is adjusted to about 8.0 to about 12.0, for use in, for example, oven cleaners, polish strippers, bathtub and tile cleaners, and some laundry and/or dishwashing detergents, wherein dirt, grease, oils and other organic and/or hydrophobic soils are present.

In an exemplary embodiment, the composition comprises sodium hydroxide, potassium hydroxide, sodium carbonate or potassium carbonate, as a pH adjuster. In another exemplary embodiment, the composition comprises citric acid, lactic acid, or another organic acid as a pH adjusting agent.

In some embodiments, the builder is present in the cleaning composition in an amount less than 30%, less than 25%, less than 20%, less than 15%, less than 10% and less than 5% by weight. In certain embodiments, the builder is present in the composition at about 0.001% to about 20%, about 0.01% to about 25%, about 0.1% to about 30%, about 0.5% to about 30%, about 1.0% to about 30%, or about 5.0% to about 30%, about 0.001% to about 1.0% by weight, or about 0.01% to less than about 0.5%, or about 0.05% to about 0.25%, or about 0.1%.

In certain embodiments, the cleaning composition can comprise one or more organic acids. In some embodiments, organic acids can serve as builders (e.g., sequestrants, softeners and/or pH adjusters), solvents, and even disinfectants.

Organic acids include but are not limited to sulfonic acids, acetic acid, formic acid, oxalic acid, fruit acid, citric acid, glycolic acid, lactic acid, malic acid, tartaric acid, benzoic acid and its derivatives (e.g., salt forms, for example, a benzyl benzoate, paramino benzoic acid, nitro benzoic acid, hydroxyl benzoic acid, fluorobenzoic acid, and benzyl salicylate), salicylic acid and 2-hydroxycarboxylic acids. 2-hydroxycarboxylic acids include, but are not limited to, tartaric acid, citric acid, malic acid, mandelic acid, acetic acid, oxalic acid, glycolic acid and lactic acid.

In some embodiments, the amount of organic acid ranges from about 0% to about 2.5% by weight, about 0.001% to about 3.0%, about 0.01% to about 3.5%, about 0.05% to about 4.0%, about 0.1% to about 4.5%, about 0.5% to about 5.0%, about 0.75% to about 5.5%, about 1.0% to about 10%, or about 1.5% to about 25%.

In some embodiments, the composition comprises an oxidant. Oxidants include, but are not limited to, peracids, hydrogen peroxide, and/or sources of hydrogen peroxide. According to the present invention, the oxidizing agent may be an oxygen bleach, including a peroxygen, peroxyhydrate or active oxygen generating compound. Suitable peroxygen bleaches for use herein include hydrogen peroxide or sources thereof.

Hydrogen peroxide sources include any compound that generates active oxygen when in contact with water. Suitable water-soluble sources of hydrogen peroxide include, for example, percarbonates, perborates, preformed percarboxylic acids, persilicates, persulphates, organic and inorganic peroxides and/or hydroperoxides. In one embodiment, the hydrogen peroxide source is sodium percarbonate. In another embodiment, the hydrogen peroxide source is sodium perborate.

In addition, other classes of peroxides can be used as an alternative to hydrogen peroxide and sources thereof or in combination with hydrogen peroxide and sources thereof. Suitable classes include dialkylperoxides, diacylperoxide, performed percarboxylic acids, organic and inorganic peroxides and/or hydroperoxides. Suitable organic peroxides/hydroperoxides include diacyl and dialkyl peroxides/hydro-peroxides such as dibenzoyl peroxide, t-butyl hydroperoxide, dilauroyl peroxide, dicumyl peroxide, and mixtures thereof. Suitable preformed peroxyacids for use in the compositions according to the present invention include diperoxydodecandioic acid DPDA, magnesium perphthalic acid, perlauric acid, perbenzoic acid, diperoxyazelaic acid and mixtures thereof.

Preferably, the oxidant is present in the cleaning composition in an amount ranging from about 0.01% to about 15% by weight, or about 0.1% to about 25% by weight, or about 0.5% to about 35%, or about 0.75% to about 45%, or about 1.0% to about 55%, or about 2.0% to about 65%, or about 3.0% to about 75%, or about 4.0% to about 85%, or about 5.0% to about 95%.

In some embodiments, the cleaning composition comprises an antioxidant. Suitable antioxidants include, for example, compounds having phenolic hydroxy functions, such as ascorbic acid and its derivatives/esters; omega-3 fatty acids (e.g., DHA, EPA); beta-carotene; catechins; curcumin; ferulic acid derivatives (e.g., ethyl ferulate, sodium ferulate); gallic acid derivatives (e.g., propyl gallate); lycopene; reductic acid; rosmarinic acid; tannic acid; tetrahydrocurcumin; tocopherol and its derivatives, including tocopheryl acetate; uric acid; or any mixtures thereof. Other suitable antioxidants are those that have one or more thiol functions (—SH), in either reduced or non-reduced form, such as glutathione, lipoic acid, thioglycolic acid, and other sulthydryl compounds. The antioxidant may be inorganic, such as bisulfites, metabisulfites, sulfites, or other inorganic salts and acids containing sulfur.

In certain embodiments, the cleaning composition can comprise one or more alkane diols. Alkane diols can serve as, for example, solvents, viscosity decreasers, fragrances, skin conditioning agents, and humectants. Suitable alkane diols include, but are not limited to, propanediol, butanediol, dodecanediol, decanediol, nonanediol, octanediol, heptanediol, hexanediol, and/or pentanediol.

In particular non-limiting embodiments, the alkane diols include, for example, 1,2-alkanediol, a 1,3-alkanediol, a 2,3-alkanediol, or a 2,4-alkanediol 1,9 nonanediol, 1,2-decanediol, 1,10-decanediol, 1,11-undecanediol, 1,2-dodecanediol, 1,12 dodecanediol, cyclododecanediol, 1,13-tridecanediol, 1,2-tetradecanediol, 1,14-tetradecanediol, 1,15-pentadecanediol, 1,16-hexadecanediol, 1,17-heptadecanediol, 1,18-octadecanediol, 1,19-nonadecanediol, 1,20-eicosanediol, 1,21-heneicosanediol, 1,22-docosanediol, 1,23-tricosanediol, 1,24-tetracosanediol, 1,25-pentacosanediol.

In certain embodiments an alkane diol is obtained from a natural product. In certain embodiments an alkane diol is chemically synthesized.

In certain embodiments, a natural thickener and/or viscosifier is added to the cleaning composition to enhance foaming activity. This counteracts the decrease in viscosity that occurs if temperature increase occurs during cleaning. Thickeners and/or viscosifiers can include, for example, cellulose-based polymers, such as xanthan gum, as well as others listed below.

In some embodiments, the cleaning compositions can comprise an auxiliary nonionic or anionic polymeric thickening component, especially cellulose thickening polymers, especially a water-soluble or water dispersible polymeric materials, having a molecular weight greater than about 20,000. By “water-soluble or water dispersible polymer” is meant that the material will form a substantially clear solution in water at a 0.5% to 1% by weight concentration at 25° C. and the material will increase the viscosity of the water either in the presence or absence of surfactant.

Examples of water-soluble polymers that can be used as an additional thickening component, include, but are not limited to, hydroxyethylcellulose, hydroxypropyl cellulose, hydroxypropyl methylcellulose, dextrans, for example Dextran purified crude Grade 2P, available from D&O Chemicals, carboxymethyl cellulose, plant exudates such as acacia, ghatti, and tragacanth, seaweed extracts such as sodium alginate, and sodium carrageenan.

Additional thickeners can include, for example, natural polysaccharide or cellulose materials. Examples of such materials are guar gum, locust bean gum, and xanthan gum. Also suitable herein preferred is hydroxyethyl cellulose having a molecular weight of about 700,000.

In certain embodiments, the cleaning composition comprises a thickener at an amount of about 0.05% to 2.0% by weight, or 0.1% to about 2.5% by weight.

In certain embodiments, the cleaning compositions can comprise a fragrance and/or essential oil, and/or one or more individual constituents derived from essential oils. In some embodiments, the essential oil has additional beneficial properties other than providing a fragrance to the cleaning composition. For example, some essential oils can have disinfecting properties.

“Essential oils,” as used herein, are volatile oils obtained from plant or animal sources, or their synthetic equivalents, and are composed of complex mixtures of several constituents such as monoterpenes and sesquiterpene hydrocarbons, monoterpene and sesquiterpene alcohols, esters, ethers, aldehydes, ketones, oxides and the like.

Essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, sandalwood, rosmarin, vervain, fleagrass, lemongrass, ratanhiae, cedar and mixtures thereof.

Examples of essential oils include, but are not limited to, cinnamon oil (e.g., cinnamon leaf oil or cinnamon bark oil), basil oil, bergamot oil, clary sage oil, ylang-ylang oil, neroli oil, sandalwood oil, frankincense oil, ginger oil, peppermint oil, lavender oil, jasmine absolute, geranium oil bourbon, spearmint oil, clove oil, patchouli oil, rosemary oil, rosewood oil, sandalwood oil, tea tree oil, mint oil, vanilla oil, lemongrass oil, oregano oil, thymol, galangal oil, cedar wood oil, balsam oils, tangerine oil, Hinoki oil, Hiba oil, ginko oil, eucalyptus oil, lemon oil, orange oil, sweet orange oil, pomegranate seed oil, pomegranate oil, manuka oil, citronella oil, curry leaf oil, and Calendula oil.

Other essential oils include Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Borneol Flakes (China), Camphor oil, Camphor powder synthetic technical, Canaga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), and Wintergreen. Each of these botanical oils is commercially available.

Individual constituents of essential oils may be isolated from the oil and used in the cleaning composition, and/or they may be entirely or partially chemically synthetic, and include, but are not limited to, thymol, oregano, curcumin, citronellol, 1-citronellol, citronellal, hydroxycitronellal, a-amylcinnamaldehyde, lyral, geraniol, farnesol, isoeugenol, eugenol, methyl isoueugenol, camphor, eucalyptol, linalool, citral, limonene, d-limonene, menthol, alpha-pinene, cinnamaldehyde, cinnamylacetic ester, cinnamic acid, ethyl cinnamate, methyl chavicol, linalool, beta-caryophyllene, geranyl acetate, nerol, elemol, β-selinene, α-pinene, sabinene, myrcene, verbenone, pinocarvone, cedrol, anethol, carvacrol, hinokitiol, berberine, ferulic acid, methyl salicylic acid, methyl salycilate, terpineol and mixtures thereof.

Further examples of individual constituents include sesquiterpenoid compounds, which may be the active compounds in the essential oils. Sesquiterpenoid compounds, containing 15 carbons, are formed biosynthetically from three 5-carbon isoprene units. Sesquiterpenoid compounds include, but are not limited to, farnesol, nerolidol, bisabolol, apritone, chamazulene, santalol, zingiberol, carotol, and caryophyllen.

In an exemplary embodiment, the cleaning composition contains essential oils or fragrances including lemon oil and/or d-limonene. Lemon oil and d-limonene compositions include mixtures of terpene hydrocarbons obtained from the essence of oranges, e.g., cold-pressed orange terpenes and orange terpene oil phase ex fruit juice, and the mixture of terpene hydrocarbons expressed from lemons and grapefruit.

The essential oils may contain minor, non-essential amounts of hydrocarbon carriers. In preferred embodiments, an essential oil or individual constituent thereof can be present in the cleaning composition in an amount ranging from about 0.001% to about 0.10% by weight, or about 0.01% to about 0.20%, or about 0.10% to about 0.30%, or about 0.15% to about 0.35%, or about 0.20% to about 0.40%, or about 0.25% to about 0.45%, or about 0.30% to about 0.50%, or about 0.40% to about 1.0%, or about 0.50% to about 2.0%.

In certain embodiments, the cleaning compositions can contain dyes, colorants and/or enzymes. These dyes and colorants can be natural (occurring in nature or slightly processed from natural materials) or synthetic. Dyes and colorants include synthetic dyes such as Liquitint® Yellow or Blue or natural plant dyes, colored speckles or pigments, such as a natural yellow, orange, red, and/or brown pigment, such as carotenoids, including, for example, beta-carotene and lycopene. In one embodiment, the composition comprises a polyoxyalkylene substituted chrornophore colorant. Colored speckles can be synthetic or natural and can include green metso beads, britasel dyed with Milliken dyes, Blue Metso or UMB.

Enzymes used in the cleaning composition include, but are not limited to, proteases, amylases, lipases, mannanases and mixtures thereof.

In a preferred embodiment, the colorants, dyes and/or enzymes comprise no more than 3.0%, no more than 2.0%, no more than 1.0%, or no more than 0.5% in the cleaning composition. In another embodiment, the colorants, dyes, enzymes and mixtures thereof can be between 0.1 to 3.0%, 0.1 to 2.0%, 0.1 to 1.0%, 0.5 to 3.0%, 0.5 to 2.0%, 0.5 to 1.0%, 1.0 to 3.0% and 1.0 to 2.0%.

In some embodiments, the cleaning compositions do not contain brighteners and/or preservatives. In alternative embodiments, the cleaning compositions may contain one or more brighteners and/or preservatives.

Brighteners include, but are not limited to optical brighteners, which for example include stillbene-triazinic derivatives.

Preservatives, when used, can include, for example, methylisothiazolinone, benzisothiazolinone, octylisothiazolinone, benzyl alcohol, potassium sorbate, bisabalol, sodium benzoate, 2-phenoxyethanol, mildewstat or bacteriostat, methyl, ethyl and propyl parabens, short chain organic acids (e.g., acetic, lactic and/or glycolic acids), bisguanidine compounds (e.g., Dantagard® and/or Glydant®) and/or short chain alcohols (e.g., ethanol and/or IPA). The mildewstat or bacteriostat includes, but is not limited to, mildewstats (including non-isothiazolone compounds) including Kathon GC/ICP®, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL®, a 2-bromo-2-nitropropane 1,3 diol, from Boots Company Ltd., PROXEL CRL, a propyl-p-hydroxybenzoate, from ICI PLC; NIPASOL M, an o-phenyl-phenol, Na salt, from Nipa Laboratories Ltd., DOWICIDE A, a 1,2-Benzoisothiazolin-3-one, from Dow Chemical Co., and IRGASAN DP 200, a 2,4,4′-trichloro-2-hydroxydiphenylether, from Ciba-Geigy A.G.

In some embodiments, the cleaning composition may comprise disinfectants and/or sanitizers. In one embodiment, the biosurfactant can also serve as a green disinfectant and/or sanitizer. In one embodiment, the essential oil thymol can be used as a green disinfectant and/or sanitizer. In one embodiment, an organic acid, such as citric acid or lactic acid can be used as a green disinfectant. In one embodiment, an amine oxide can be used as a disinfectant, such as LDAO, DDA, lauramine oxide or myristamine oxide.

Although the compositions may contain minor amounts of traditional antimicrobials as preservatives or other uses, in preferred embodiments, the composition comprises no non-natural disinfectants or sanitizers, such as quaternary ammonium antimicrobials, biguanides or phenolics.

Non-limiting examples of these quaternary compounds include benzalkonium chlorides and/or substituted benzalkonium chlorides, di(C6-C14)alkyl di short chain (C1-4 alkyl and/or hydroxyalkl) quatemaryammonium salts, N-(3-chloroallyl)hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethyl-enzylmmonium chlorides, and mixtures thereof.

Biguanide antimicrobial actives including, but not limited to polyhexamethylene biguanide hydrochloride, p-chloro-henyl biguanide; 4-chlorobenzhydryl biguanide, halogenated hexidine such as, but not limited to, chlorhexidine(1,1′-hexamethylene-bis-5-(4-chlorophenyl biguanide) (CHG) and its salts are also in this class.

Although the compositions contain surfactants, which lower the surface energy during cleaning, the compositions generally contain no surface modifying agents, which provide a lasting modification to the cleaned surface. Surface modifying agents are generally polymers other than the cellulosic thickening polymers and the others mentioned above, and provide spreading of the water on the surface or beading of water on the surface. This effect is seen when the surface is rewetted and even when subsequently dried after the rewetting.

Examples of surface modifying agents include polymers and co-polymers of N,N-dimethyl acrylamide, acrylamide, and certain monomers containing quaternary ammonium groups or amphoteric groups, along with co-monomers that favor adsorption of water, such as, for example, acrylic acid and other acrylate salts, sulfonates, betaines, and ethylene oxides. Other examples include organosilanes and organosilicone polymers, hydrophobic amphoteric polymers, nanoparticles and hydrophobic organic polymers, such as waxes derived from petrochemicals.

The cleaning composition can be used independently from or in conjunction with an absorbent and/or adsorbent material. The cleaning composition can be pre-loaded onto an absorbent and/or adsorbent material, post-absorbed and/or post adsorbed by a material during use, and/or be used separately from an absorbent and/or adsorbent material.

A wide variety of materials can be used as the cleaning substrate. For instance, the cleaning composition can be formulated to be used in conjunction with a cleaning wipe, sponge (cellulose, synthetic, etc.), paper towel, napkin, cloth, towel, rag, mop head, squeegee, toilet wand and/or other cleaning device that includes an absorbent and/or adsorbent material. The substrate should have sufficient wet strength, abrasivity, loft and porosity. The terms “nonwoven” or “nonwoven web” means a web having a structure of individual fibers or threads which are interlaid, but not in an identifiable manner as in a knitted web. Nonwoven webs have been formed from many processes, such as, for example, meltblowing processes, spunbonding processes, and bonded carded web processes.

In an exemplary embodiment, a cleaning wipe, upon which the improved cleaning composition can be loaded thereon, can be made of an absorbent/adsorbent material. Typically, the cleaning wipe has at least one layer of nonwoven material. Non-limiting examples of commercially available cleaning wipes that can be used include DuPont 8838, Dexter ZA, Dexter 10180, Dexter M10201,Dexter 8589, Ft. James 836, and Concert STD60LN. All of these cleaning wipes include a blend of polyester and wood pulp. Dexter M10201 also includes rayon, a wood pulp derivative. The loading ratio of the cleaning composition onto the cleaning wipe can be about 2-5:1, or about 3-4:1. The cleaning composition is loaded onto the cleaning wipe in any number of manufacturing methods. Typically, the cleaning wipe is soaked in the cleaning composition for a period of time until the desired amount of loading is achieved. The cleaning wipe loaded with the improved cleaning composition provides excellent cleaning with little or no streaking/filming.

In certain embodiments, the cleaning composition can be loaded into a water-soluble capsule or pod, for example, in the case of auto-dish detergents and laundry detergents. The capsule or pod can be formulated out of, for example, a polyvinyl alcohol membrane, or other water-soluble materials.

In one specific embodiment, the cleaning composition of the subject invention is a dish cleaning composition for use in hand-washing dish formulations and/or in auto-dish formulations. In certain embodiments, which are particularly useful in hand-washing dish formulations, the dish formulation is suitable for sensitive skin and eyes. The composition can be formulated with antioxidants, which, in combination with the SLP, reduce inflammatory responses to detergents and other additives in the formulation.

In one specific embodiment, the cleaning composition of the subject invention is a laundry formulation for use in laundry washing machines. In certain embodiments, which are particularly useful for cleaning baby clothes and bedding, the laundry formulation is suitable for sensitive skin and eyes. Advantageously, the SLP can be useful for reducing the amounts of chemical surfactants used in laundry formulations, while reducing, or even treating, skin and/or eye irritation caused by these surfactants.

### Healthcare Formulations

The chelating compositions can be utilized in formulations intended for the treatment of, for example, heavy metal poisoning. The healthcare composition can comprise one or more pharmaceutically acceptable carriers, and/or excipients, and can be formulated into preparations, for example, solid, semi-solid, liquid, or gaseous forms, such as tablets, capsules, powders, granules, ointments, solutions, suppositories, injections, inhalants, and aerosols.

The term “pharmaceutically acceptable” as used herein means compatible with the other ingredients of a pharmaceutical composition and not deleterious to the recipient thereof.

Carriers and/or excipients according the subject invention can include any and all solvents, diluents, buffers (such as, e.g., neutral buffered saline, phosphate buffered saline, or optionally Tris-HCl, acetate or phosphate buffers), oil-in-water or water-in-oil emulsions, aqueous compositions with or without inclusion of organic co-solvents suitable for, e.g., IV use, solubilizers (e.g., Polysorbate 65, Polysorbate 80), colloids, dispersion media, vehicles, fillers, amino acids (e.g., glycine), proteins, disintegrants, binders, lubricants, wetting agents, emulsifiers, sweeteners, colorants, flavorings, aromatizers, thickeners (e.g. carbomer, gelatin, or sodium alginate), coatings, preservatives (e.g., Thimerosal, benzyl alcohol, polyquaterium), antioxidants (e.g., ascorbic acid, sodium metabisulfite), tonicity controlling agents, absorption delaying agents, adjuvants, bulking agents (e.g., lactose, mannitol) and the like. The use of carriers and/or excipients in the field of drugs and supplements is well known. Except for any conventional media or agent that is incompatible with the target health-promoting substance or with the composition, carrier or excipient use in the subject compositions may be contemplated.

In one embodiment, the composition can be made into aerosol formulations so that, for example, it can be nebulized or inhaled. Suitable pharmaceutical formulations for administration in the form of aerosols or sprays are, for example, powders, particles, solutions, suspensions or emulsions. Formulations for oral or nasal aerosol or inhalation administration may also be formulated with carriers, including, for example, saline, polyethylene glycol or glycols, DPPC, methylcellulose, or in mixture with powdered dispersing agents or fluorocarbons. Aerosol formulations can be placed into pressurized propellants, such as dichlorodifluoromethane, propane, nitrogen, fluorocarbons, and/or other solubilizing or dispersing agents known in the art. Illustratively, delivery may be by use of a single-use delivery device, a mist nebulizer, a breath-activated powder inhaler, an aerosol metered-dose inhaler (MDI), or any other of the numerous nebulizer delivery devices available in the art. Additionally, mist tents or direct administration through endotracheal tubes may also be used.

In one embodiment, the composition can be formulated for administration via injection, for example, as a solution or suspension. The solution or suspension can comprise suitable non-toxic, parenterally-acceptable diluents or solvents, such as mannitol, 1,3-butanediol, water, Ringer's solution, or isotonic sodium chloride solution, or suitable dispersing or wetting and suspending agents, such as sterile, non-irritant, fixed oils, including synthetic mono- or diglycerides, and fatty acids, including oleic acid. One illustrative example of a carrier for intravenous use includes a mixture of 10% USP ethanol, 40% USP propylene glycol or polyethylene glycol 600 and the balance USP Water for Injection (WFI). Other illustrative carriers for intravenous use include 10% USP ethanol and USP WFI; 0.01-0.1% triethanolamine in USP WFI; or 0.01-0.2% dipalmitoyl diphosphatidylcholine in USP WFI; and 1-10% squalene or parenteral vegetable oil-in-water emulsion. Water or saline solutions and aqueous dextrose and glycerol solutions may be preferably employed as carriers, particularly for injectable solutions. Illustrative examples of carriers for subcutaneous or intramuscular use include phosphate buffered saline (PBS) solution, 5% dextrose in WFI and 0.01-0.1% triethanolamine in 5% dextrose or 0.9% sodium chloride in USP WFI, or a 1 to 2 or 1 to 4 mixture of 10% USP ethanol, 40% propylene glycol and the balance an acceptable isotonic solution such as 5% dextrose or 0.9% sodium chloride; or 0.01-0.2% dipalmitoyl diphosphatidylcholine in USP WFI and 1 to 10% squalene or parenteral vegetable oil-in-water emulsions.

In one embodiment, the composition can be formulated for administration via topical application onto the skin, for example, as topical compositions, which include rinse, spray, or drop, lotion, gel, ointment, cream, foam, powder, solid, sponge, tape, vapor, paste, tincture, or using a transdermal patch. Suitable formulations of topical applications can comprise in addition to any of the pharmaceutically active carriers, for example, emollients such as carnauba wax, cetyl alcohol, cetyl ester wax, emulsifying wax, hydrous lanolin, lanolin, lanolin alcohols, microcrystalline wax, paraffin, petrolatum, polyethylene glycol, stearic acid, stearyl alcohol, white beeswax, or yellow beeswax. Additionally, the compositions may contain humectants such as glycerin, propylene glycol, polyethylene glycol, sorbitol solution, and 1,2,6 hexanetriol or permeation enhancers such as ethanol, isopropyl alcohol, or oleic acid.

In one embodiment, the compositions are formulated as an orally-consumable healthcare product, such as, for example a food item, capsule, pill, or drinkable liquid. An orally deliverable pharmaceutical is any physiologically active substance delivered via initial absorption in the gastrointestinal tract or into the mucus membranes of the mouth. The topic compositions can also be formulated as a solution that can be administered via, for example, injection, which includes intravenously, intraperitoneally, intramuscularly, intrathecally, or subcutaneously. In other embodiments, the subject compositions are formulated to be administered via the skin through a patch or directly onto the skin for local or systemic effects. The compositions can be administered sublingually, buccally, rectally, or vaginally. Furthermore, the compositions can be sprayed into the nose for absorption through the nasal membrane, nebulized, inhaled via the mouth or nose, or administered in the eye or ear.

Orally consumable products according to the invention are any preparations or compositions suitable for consumption, for nutrition, for oral hygiene, or for pleasure, and are products intended to be introduced into the human or animal oral cavity, to remain there for a certain period of time, and then either be swallowed (e.g., food ready for consumption or pills) or to be removed from the oral cavity again (e.g., chewing gums or products of oral hygiene or medical mouth washes). While an orally-deliverable pharmaceutical can be formulated into an orally consumable product, and an orally consumable product can comprise an orally deliverable pharmaceutical, the two terms are not meant to be used interchangeably herein.

Orally consumable products include all substances or products intended to be ingested by humans or animals in a processed, semi-processed, or unprocessed state. This also includes substances that are added to orally consumable products (particularly food and pharmaceutical products) during their production, treatment, or processing and intended to be introduced into the human or animal oral cavity.

Orally consumable products can also include substances intended to be swallowed by humans or animals and then digested in an unmodified, prepared, or processed state; the orally consumable products according to the invention therefore also include casings, coatings, or other encapsulations that are intended to be swallowed together with the product or for which swallowing is to be anticipated.

In one embodiment, the orally consumable product is a capsule, pill, syrup, emulsion, or liquid suspension containing a desired orally deliverable substance. In one embodiment, the orally consumable product can comprise an orally deliverable substance in powder form, which can be mixed with water or another liquid to produce a drinkable orally-consumable product.

In some embodiments, the orally-consumable product according to the invention can comprise one or more formulations intended for nutrition or pleasure. These particularly include baking products (e.g., bread, dry biscuits, cake, and other pastries), sweets (e.g., chocolates, chocolate bar products, other bar products, fruit gum, coated tablets, hard caramels, toffees and caramels, and chewing gum), alcoholic or non-alcoholic beverages (e.g., cocoa, coffee, green tea, black tea, black or green tea beverages enriched with extracts of green or black tea, Rooibos tea, other herbal teas, fruit-containing lemonades, isotonic beverages, soft drinks, nectars, fruit and vegetable juices, and fruit or vegetable juice preparations), instant beverages (e.g., instant cocoa beverages, instant tea beverages, and instant coffee beverages), meat products (e.g., ham, fresh or raw sausage preparations, and seasoned or marinated fresh meat or salted meat products), eggs or egg products (e.g., dried whole egg, egg white, and egg yolk), cereal products (e.g., breakfast cereals, muesli bars, and pre-cooked instant rice products), dairy products (e.g., whole fat or fat reduced or fat-free milk beverages, rice pudding, yoghurt, kefir, cream cheese, soft cheese, hard cheese, dried milk powder, whey, butter, buttermilk, and partly or wholly hydrolyzed products containing milk proteins), products from soy protein or other soy bean fractions (e.g., soy milk and products prepared thereof, beverages containing isolated or enzymatically treated soy protein, soy flour containing beverages, preparations containing soy lecithin, fermented products such as tofu or tempeh products prepared thereof and mixtures with fruit preparations and, optionally, flavoring substances), fruit preparations (e.g., jams, fruit ice cream, fruit sauces, and fruit fillings), vegetable preparations (e.g., ketchup, sauces, dried vegetables, deep-freeze vegetables, pre-cooked vegetables, and boiled vegetables), snack articles (e.g., baked or fried potato chips (crisps) or potato dough products and extrudates on the basis of maize or peanuts), products on the basis of fat and oil or emulsions thereof (e.g., mayonnaise, remoulade, and dressings), other ready-made meals and soups (e.g., dry soups, instant soups, and pre-cooked soups), seasonings (e.g., sprinkle-on seasonings), sweetener compositions (e.g., tablets, sachets, and other preparations for sweetening or whitening beverages or other food). The present compositions may also serve as semi-finished products for the production of other compositions intended for nutrition or pleasure.

### Methods of Sequestering or Dissolving Metals, Minerals, or Elements

In certain embodiments, the subject invention provides a method for sequestering and/or dissolving metals, elements, or minerals, wherein the method comprises contacting a chelating composition comprising a biosurfactant with a metal, mineral, or element for a period of time to yield a treated solution. In some embodiments, the subject methods comprise applying a chelating composition comprising a biosurfactant and, optionally, other components, such as, for example, chelating agents, non-biological surfactants, or any combination thereof to a liquid or solid. Advantageously, the subject invention further provides methods for reducing the amount of a traditional chelating agent needed to achieve a desired chelating function.

In certain embodiments, the subject invention provides a method for preventing and/or removing scale deposits on surfaces, e.g., calcium carbonate scales, wherein a chelating composition comprising a biosurfactant is applied to a liquid containing a dissolved metal, mineral or element, or to a surface containing a scale deposit. In certain exemplary embodiments, when used for scale prevention and/or inhibition, the composition comprises a linear sophorolipid, e.g., from 5 to 250 ppm, 10 to 200 ppm, or 50 to 100 ppm, with respect to the total composition.

In certain embodiments, the composition is applied to fluids and/or to a surface to disperse scale ions and/or to maintain suspension of scale ions in the fluids so as to reduce agglomeration and/or precipitation thereof and thus, prevent formation of deposits on surfaces.

In certain embodiments, the compositions and methods are used for remediating, or removing, scale deposits that have formed on surfaces within an oil production environment, or in industrial or household machinery. The chelating composition can be used in combination with, as a synergist with, and/or in place of, existing descaling and/or scale inhibiting substances, e.g., polyphosphates, phosphate esters, phosphonates, polymers (e.g., polyacrylates), acetic acid, citric acid, formic acid, lactic acid, malic acid, oxalic acid, tartaric acid, uric acid, propionic acid, butyric acid, sorbic acid, fumaric acid, benzoic acid, hydrofluoric acid, caproic acid, salicylic acid, gluconic acid, pyruvic acid, adipic acid, trichloroacetic acid, glycolic acid, cinnamic acid, carboxylic acids, succinic acid, carbonic acid, glutaric acid, decanoic acid, ascorbic acid, hydrochloric acid, sulfuric acid, nitric acid, phosphoric acid, boric acid, perchloric acid, hydrofluoric acid, hydrobromic acid, and sulfonic acid.

In certain embodiments, the composition can be mixed with a liquid or applied to a surface by, for example, spraying using, for example, a spray bottle or a pressurized spraying device. The composition can also be applied using a cloth or a brush, wherein the composition is rubbed, spread or brushed onto a surface. Furthermore, the composition can be applied to a surface by dipping, dunking or submerging the surface into a container having the composition therein. The chelating compositions of the subject invention can be applied to a variety of inorganic or organic objects such as, for example, steel, iron, aluminum, wood, plastic, gypsum, paper, silk, glass, cotton, concrete, plaster, clay, stucco, plastic, rubber, hair, skin, fur, or plants. The step can be repeated as many times as necessary to achieve a desired sequestration and/or dissolution of metals, minerals, or elements.

In certain embodiments, the time period in which the chelating composition can be contacted with a liquid containing the metal, mineral, or element, or a solid with the metal, mineral, or element on the surface of said solid is about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours.

In certain embodiments, the methods comprise applying the chelating composition to the liquid or solid for the period of time in which the liquid containing the metal, mineral, or element is being produced or until the amount of metals, minerals, or elements, in the liquid or on the solid that have been sequestered or dissolved is determined to be satisfactory. Removing substantial amounts of metals, minerals, or elements from the liquid or solid can reduce maintenance costs, often resulting from the need to remove buildup, and allow for efficient industrial production.

The methods of the subject invention can be carried out at ambient temperature, and/or at a temperature of about 15° C. to about 50° C., about 20° C. to about 40° C., about 20° C. to about 35° C., about 20° C. to about 30° C., about 25° C., about 40° C. to 120° C., about 50° C. to about 100° C., about 60° C. to about 100° C., about 70° C. to about 100° C., about 80° C. to about 100° C., or about 100° C. In certain embodiments, a temperature higher than ambient temperature can be provided using a microwave, ultrasound, induction heating, plasma, electricity, or any combination thereof.

The methods of the subject invention can be carried out at ambient pressure, and/or at a pressure of about 50 bars, 75 bars, 100 bars, or greater than 100 bars.

In certain embodiments, the subject invention provides a method for sequestering and/or dissolving metals, minerals, or elements from various sources, including, for example, homes, a subject's blood or organs, mining sites, quarrying sites, agricultural sites, oil and gas wells, hydraulic fracturing site, offshore oil drilling rig, paper and pulp production sites, textile production sites, food and beverage production sites, Superfund sites, and industrial sites.

In certain embodiments, the metal that is sequestered and/or dissolved is calcium, magnesium, iron, copper, nickel, gold, silver, molybdenum, aluminum, lead, tungsten, chromium, cadmium, zinc, or arsenic.

In certain embodiments, the chelating compositions can be used in various products, including, for example, descalers, cleaners, personal care products, cosmetics, foods, beverages, and pharmaceuticals. In certain embodiments, the chelating compositions can neutralize and/or sequester metal ions that can alter the taste, color, clarity, and stability of, for example, a food, beverage, pharmaceutical, cosmetic, cleaning solution, or descaling solution.

In certain embodiments, the chelating compositions can be used for HI&I cleaning, e.g., in laundry detergents, dishwashing detergents, dish soaps, bathroom and kitchen surface cleaners, toilet cleaners, all-purpose cleaners, floor cleaners, and glass cleaners. The cleaning compositions can, for example, remove and/or prevent scale deposits, water spots, biofilms, soap scum, mold and mildew. In certain embodiments, the compositions can be used in rinse-aid formulations for reducing dullness on glass and dishes.

In certain embodiments, the chelating compositions can be used in water softening processes to reduce hardwater (i.e., minerals, including dissolved calcium and magnesium) in the water, including, for example, reducing buildup on surfaces of the hardwater deposits.

In certain embodiments, the chelating compositions can be used in personal care products, to bind metallic impurities that would otherwise interfere with the stability and shelf-life of the formulations. Such personal care products can include, for example, cosmetics, hand soaps, skin care, cleansers, deodorants, hair care, oral care, and ear and eye care products.

In certain embodiments, the chelating compositions can be used as pharmaceuticals or as additives to pharmaceuticals. In certain embodiments, the subject chelating compositions can be used as pharmaceuticals to, for example, treat metal poisoning by, for example, lead, arsenic, or mercury; for imaging of a patients, including, for example, MRI and PET imaging; and, for treating hypercalcemia (i.e., high calcium blood levels). In certain embodiments, the chelating composition is an antimicrobial agent.

In certain embodiments, the chelating compositions can be used for preserving food, wherein the chelating composition is mixed with the food to sequester metal ions that can facilitate enzymatic reactions leading to color and flavor deterioration.

In certain embodiments, the chelating compositions can be used for treatment of soil, water and wastewater that contain and/or are polluted by heavy metals.

In certain embodiments, the chelating compositions can be used for the preparation or cleaning of metal surfaces. In certain embodiments, the chelating compositions can used before plating a metal surface (e.g., copper-nickel-chrome), reduce oxide formation, rust cleaning, or oxide removal.

In certain embodiments, the chelating compositions can be used during the synthesis of polymers, including, for example, styrene-butadiene polymerization or polyvinyl chloride polymerization, particularly to reduce or eliminate the buildup of polymers on the equipment used during the synthesis, stabilizing the polymers, and stabilizing the rate of synthesis of the polymers.

In certain embodiments, the chelating compositions can be used as additives in the pulp and paper industry. Metal ions catalyze the decomposition of hydrogen peroxide, which can affect the color of the paper product. The use of chelating agents can result in lower bleaching costs through the reduction of metal ion catalyzed bleach degradation reactions.

In certain embodiments, the chelating compositions can be used in various steps of the textile production process, including, for example, sequestering metal ions that alter the bleaching and dying of textiles or the cleaning (e.g., scouring) of textiles.

In certain embodiments, water can be pumped or otherwise added to a geological formation containing the metal, element, mineral, compound, or other material of interest before the metal, mineral, compound, element, or other material of interest is extracted (i.e., mined or pumped).

In certain embodiments, the subject compositions and methods can be used to sequester and/or dissolve contaminating metals, element, or mineral, from extracted slurries, crude oil, or equipment used in the oil and gas production process. The contaminating metals can precipitate and plug or otherwise reduce the flow of liquids used in the extraction and processing of crude oil or other materials of interest.

In certain embodiments, the chelating compositions can be used as an additive to fertilizers in order to increase the solubility or availability of other components of the fertilizer, including, for example, trace metal iron.

In certain embodiments, the chelating compositions can be used to remove existing scale deposits particularly on surfaces of equipment used to heat materials, that include, for example, boilers, evaporators, heat exchanger, filters, and kettles.

In certain embodiments, the microbe-containing and/or biosurfactant-containing composition can dissolve a sedimented or precipitated metal, mineral, or element into a water-soluble inert complex.

In certain embodiments, the microbe-containing and/or biosurfactant-containing composition can neutralize a metal ion.

The compositions can be applied to liquids or vessels that contain liquids that reside at a range of temperatures and aquatic environments, such as, for example, a stream, river, waterway, ocean, sea, lake, pond, runoff area, containment ponds, piping, filter, press, membrane, column, screen, cone, dewaterer, classifier, scraper, hydrocyclone, agitator, drum, disk, or industrial wastewater treatment/holding tank. In certain embodiments, the chelating composition can be added to the vessels that contain liquids before the liquid composition is added to said vessel.

The chelating composition can be applied to a liquid and, optionally, mixed by adding, pouring, stirring, shaking, bubbling, or combining.

In certain embodiments, the amount of the chelating composition applied is about 0.1 to 15%, about 0.1 to 10%, about 0.1 to 5%, about 0.1 to 3%, about 0.1%, or about 1 vol % based on an amount of the liquid containing the metal, mineral, or element.

In certain embodiments, the methods of the subject invention result in at least a 25% increase in the rate of sequestering of metals, preferably at least a 50% increase, after one treatment. In certain embodiments, the liquid or surface can be treated multiple times to further increase the amount of sequestered metals or rate of sequestering of metals.

Advantageously, in certain embodiments, the chelating composition according to the subject invention provides enhanced or increased efficiency at sequestering and/or dissolving metals, minerals, or elements from liquids or surfaces with limited negative environmental impacts. Additionally, the methods of the subject invention do not require complicated equipment or high energy consumption, and production of the chelating composition can be performed on site, for example, at an industrial site. In certain embodiments, the subject chelating composition can result in a decreased use of synthetic chelating agents or other potentially harmful chemicals during the sequestration and/or dissolution of metals, minerals, or elements.

### Cleaning Methods

In certain embodiments, the subject invention provides methods for cleaning surfaces by applying a cleaning composition according to the subject invention to the surface. The surface can be a hard surface, a porous surface, a non-porous surface, a textile, or an organic surface.

In certain embodiments, the cleaning composition is applied to the surface by spraying using, for example, a spray bottle or a pressurized spraying device. In certain embodiments, the cleaning composition is applied to the surface by way of a dishwasher (auto-dish) or laundry washing machine.

In certain preferred embodiments, the composition is sprayed at high pressure to the surface. In preferred embodiments, high pressure is defined as 1,000 psi to 10,000 psi. The exact pressure can vary depending upon the type of contaminant and the type of surface being cleaned. In one embodiment, the pressure can range from about 1,000 to about 2,000 psi for smaller, household-type cleaning, from about 2,000 to about 3,000 psi for moderately-sized tasks, or from 3,000 to about 7,000 or 8,000 psi for larger scale, industrial cleaning jobs.

In certain embodiments, the spraying of the composition, whether under higher pressure or standard pressure, can be performed under elevated temperature to further enhance the efficiency of the cleaning. For example, in some embodiments, the spraying is performed at a temperature from about 25° C. to 300° C., 35° C. to 250° C., 45° C. to 200° C. or 55° C. to 150° C.

In one embodiment, the surface is allowed to soak with the cleaning composition thereon for a sufficient time to facilitate the removal of the contaminant. For example, soaking can occur for up to 5 minutes to 72 hours, 10 minutes to 56 hours, 15 minutes to 48 hours, 20 minutes to 36 hours, 25 minutes to 24 hours, or as long as needed.

In one embodiment, the method further comprises the step of removing the cleaning composition and contaminant from the surface. This can be achieved by, for example, rinsing or spraying water onto the surface, and/or rubbing or wiping the surface with a cloth until the cleaning composition and contaminant have been freed from the surface. Rinsing or spraying with water can be performed before and/or after rubbing or wiping the surface with a cloth. In some embodiments, the rinse spraying is performed under elevated pressure and/or elevated temperature, for example, at pressures and/or temperatures outlined above for application of the cleaning composition. In certain embodiments, an abrasive substance is applied concurrently with the pressurized spray, e.g., sandblasting.

In another embodiment, mechanical methods can be used to remove the contaminant and/or cleaning composition from the surface after application of the cleaning composition. For example, a dishwasher, laundry washing machine, agitator, drill, hammer, sandpaper, or scraper can be used for freeing contaminants from surfaces that are particularly difficult to remove due to, for example, the amount of contaminant, the type of contaminant and/or the type of surface.

### Examples

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Cleaners

In one embodiment, the chelating composition can be formulated into an all-purpose cleaner that can be used on a variety of surfaces, such as, for example, counters, drains, sinks, tubs, toys, dishes, windows, faucets, stone and plastic. Preferably the pH is within a range of about 5.0 to about 8.0 so that the composition may be used on a variety of surfaces and/or materials without damaging or corroding the surface and/or material.

In one embodiment, the chelating composition can be formulated into a liquid bathroom (glass, tub, tile, toilet) cleaner. The pH can range from about 0.5 to about 12.5, depending upon the type of soil to be treated (more alkaline for oils and greases, more acidic for dissolving stains and mineral deposits).

| The formulations can | |
|---|---|
| be used as a liquid | |
| spray, concentrate | |
| and/or loaded onto a | |
| substrate, such as a | |
| wipe. Ingredient | Non-Limiting Examples (in any combination) |
| Water | Hardwater |
| Solvent(s) | Ethanol and/or isopropanol |
| Clarifying additive(s) | Modified and/or natural sophorolipid, rhamnolipid, mannosylerythritol lipid or |
| | lipopeptide, and/or a mixture thereof |
| Builder(s), | EDTA, disodium EDTA, HEDTA, DTPA, NTA, STPP, rhamnolipid, citric |
| softener(s) and/or | acid, sodium gluconate, sodium citrate, and/or sodium aluminosilicate |
| chelator(s) | |
| (optional) | |
| pH adjuster(s) | Sodium silicate, sodium carbonate, potassium carbonate, citric acid, sodium |
| (optional) | hydroxide, potassium hydroxide, lactic acid, potassium citrate and/or sodium |
| | citrate |
| Additional | Sodium lauryl sulfate, caprylyl/capryl glucoside, lauryl glucoside, decyl |
| surfactant(s) | glucoside, myristyl glucoside, lauramine oxide, myristamine oxide, SLES, |
| (optional) | LABS, SLABS, alkyl polyglucosides, ammonium lauryl sulfate (ALS), Triton |
| | GR-5M |
| Preservative(s) | Methylisothiazolinone, octylisothiazolinone and/or benzisothiazolinone |
| (optional) | |
| Fragrance(s) | d-limonene, thymol, citral, lavender, and/or other essential oils |
| (optional) | |
| Colorant(s) | Blue, yellow and/or red colorant |
| (optional) | |
| Viscosity modifier(s) | Xanthan gum |
| (optional) | |
| Antioxidant(s) | DHA, EPA, tocopherols, vitamin C, carotenoids |
| (optional) | |

### Example 2—Dishwashing Liquid and Dishwasher Detergent

In one embodiment, the chelating composition can be formulated into a dishwashing (handwashing) liquid. Preferably the pH is within a range of about 5.0 to about 8.0 so that the composition is not irritating to skin or eyes. When formulated as a dishwashing (auto-dish) detergent, the pH is preferably within a range of about 8.0 to about 12.5, which is suitable for cleaning fats, oils and greases from dishes.

| Ingredient | Non-Limiting Examples (in any combination) |
|---|---|
| Water | Hardwater |
| Solvent(s) | Ethanol and/or isopropanol |
| Clarifying | Modified and/or natural sophorolipid, rhamnolipid, mannosylerythritol lipid or |
| additive(s) | lipopeptide, and/or a mixture thereof |
| Builder(s), | EDTA, disodium EDTA, HEDTA, DTPA, NTA, STPP, rhamnolipid, citric |
| softener(s) and/or | acid, sodium gluconate, sodium citrate, and/or sodium aluminosilicate |
| chelator(s) | |
| (optional) | |
| pH adjuster(s) | Sodium silicate, sodium carbonate, potassium carbonate, citric acid, sodium |
| (optional) | hydroxide, potassium hydroxide, lactic acid, potassium citrate and/or sodium |
| | citrate |
| Additional | Alkyl polyglucosides; SDS/SLS; SLES; ammonium lauryl sulfate (ALS); |
| surfactant(s) | Triton GR-5M; caprylyl/capryl glucoside; lauryl glucoside; decyl glucoside; |
| (optional) | myristyl glucoside; lauramine oxide and/or myristamine oxide |
| Preservative(s) | Methylisothiazolinone, octylisothiazolinone and/or benzisothiazolinone |
| (optional) | |
| Fragrance(s) | d-limonene, thymol, citral, lavender, and/or other essential oils |
| (optional) | |
| Colorant(s) | Blue, yellow and/or red colorant |
| (optional) | |
| Foam stabilizer(s) | Glycerin |
| (optional) | |
| Viscosity | Magnesium chloride; xanthan gum |
| modifier(s) | |
| (optional) | |
| Encapsulation | Polyvinyl alcohol; glycerin |
| membrane | |
| (optional for | |
| dishwashing pod | |
| formulation) | |
| Antioxidant(s) | DHA, EPA, tocopherols, vitamin C, carotenoids |
| (optional) | |

### Example 3—Laundry Detergent

In one embodiment, the chelating composition can be formulated into a laundry detergent. Preferably the pH is within a range of about 8.0 to about 12.5, more preferably about 8.0 to about 11.0, which is suitable for cleaning stains and other soils from fabrics.

| Ingredient | Non-Limiting Examples (in any combination) |
|---|---|
| Water | Hardwater |
| Solvent(s) | Ethanol and/or isopropanol |
| Clarifying additive(s) | Modified and/or natural sophorolipid, rhamnolipid, mannosylerythritol |
| | lipid or lipopeptide, and/or a mixture thereof |
| Builder(s) | Softener(s) and/or chelator(s), such as, for example, a rhamnolipid, citric |
| (optional) | acid, sodium gluconate, sodium citrate, and/or sodium aluminosilicate; |
| | pH adjuster(s), such as, for example, sodium silicate, sodium carbonate, |
| | potassium carbonate, citric acid, sodium hydroxide, potassium hydroxide, |
| | lactic acid, potassium citrate and/or sodium citrate |
| Additional surfactant(s) | Sodium lauryl sulfate, caprylyl/capryl glucoside, lauryl glucoside, decyl |
| (optional) | glucoside, myristyl glucoside, lauramine oxide, myristamine oxide, SLES, |
| | LABS, SLABS, alkyl polyglucosides, ammonium lauryl sulfate (ALS), |
| | Triton GR-5M |
| Enzyme(s) | Proteases, amylases, mannanases and/or lipases (with optional enzyme |
| (optional) | stabilizer, such as, e.g., glycerin, calcium chloride) |
| Preservative(s) | Methylisothiazolinone, octylisothiazolinone and/or benzisothiazolinone |
| (optional) | |
| Fragrance(s) | d-limonene, thymol, citral, lavender, and/or other essential oils |
| (optional) | |
| Colorant(s) | Blue, yellow and/or red colorant |
| (optional) | |
| Viscosity modifier(s) | Sodium chloride |
| (optional) | |
| Anti-foam agent(s) | Fatty acids (e.g., oleic acid) |
| (optional) | |
| Antioxidant(s) | DHA, EPA, tocopherols, vitamin C, carotenoids |
| (optional) | |
| Encapsulation | Water-soluble polyvinyl alcohol (PVA) membrane; bittering agent |
| membrane (optional for | |
| laundry detergent pod | |
| formulation) | |

### Example 4—Clarifying Shampoo

In one embodiment, the chelating composition is formulated into a clarifying shampoo to help reduce the negative effects of hardwater on the scalp and hair. Preferably the pH is within a range of about 7.0 to 10.0 to aid in the removal of buildup and mineral deposits.

| Ingredient | Non-Limiting Examples (in any combination) |
|---|---|
| Water | |
| Clarifying additive(s) | Modified and/or natural sophorolipid, rhamnolipid, mannosylerythritol |
| | lipid or lipopeptide, and/or a mixture thereof |
| Solvent(s) | Ethanol, mineral oil |
| (optional) | |
| Additional surfactant(s) | Cocamidopropyl betaine; Sodium Methyl Cocoyl Taurate, |
| (optional) | |
| Moisturizer/ | Panthenol, sodium hyaluronate, glycerin, Aloe vera, honey, urea, alpha |
| humectant(s) (optional) | hydroxy acids, propylene glycol, sorbitol, |
| Viscosity modifier/ | Sodium chloride, xanthan gum, paraffin, dimethicone, polyethylene |
| thickener(s) | glycol, polyquaternium-10 |
| (optional) | |
| Emollient(s) | Plant oils, mineral oil, shea butter, coconut oil, cocoa butter, |
| (optional) | petrolatum, fatty acids (e.g., animal oils, including emu, mink, and |
| | lanolin), petrolatum, paraffin, beeswax, squalene, cetyl alcohol, |
| | triethlhexanoin |
| Emulsifier(s) | Lecithin, petroleum jelly, polysorbates, stearamidopropyl |
| (optional) | dimethylamine, laureth-4, potassium cetyl sulfate, benzalkonium |
| | chloride, behentrimonium methosulphate, cetearyl alcohol, stearic acid |
| | and glyceryl stearate |
| Preservative(s) | Aldehydes, glycol ethers, methylisothiazolinone, organic acids, sorbic |
| (optional) | acid, parabens, EDTA/disodium EDTA, benzyl alcohol, sodium |
| | benzoate |
| Antioxidant(s) | Vitamin E, Vitamin C, ferulic acid, retinol, CoQ10, niacinamide, |
| (optional) | resveratrol, curcumin, DHA, EPA |
| Chelator(s) | EDTA, disodium EDTA, gluconolactone, sodium citrate and/or citric |
| (optional) | acid |
| pH adjuster(s) | Coconut acid, citric acid, sodium hydroxide, potassium hydroxide, |
| (optional) | lactic acid, |
| Fragrance(s) | Linalool, d-limonene, thymol, citral, lavender, hexyl cinnamal, |
| (optional) | essential oils, benzyl salicylate, other naturally-derived or synthetic |
| | perfumes |
| Colorant(s) | Caramel, annatto extract, dehydrated beets, fruit juice, carrot oil, |
| (optional) | FD&C Blue 1, Blue 2, Green 3, Red 3, Yellow 5, titanium dioxide |

1. A method for sequestering and/or dissolving a metal, mineral, or element, the method comprising contacting a composition comprising the metal, mineral, or element with a chelating composition comprising a biosurfactant for a period of time sufficient to achieve said sequestering and/or dissolving.

2. The method of claim 1, wherein the composition comprising the metal, mineral, or element is a solid or a liquid.

3. The method of claim 2, wherein the liquid is crude oil, a pulp, a mining slurry, a fertilizer, a cleaner, a descaler, a water softener, or a cosmetic.

4. The method of claim 2, wherein the metal, mineral, or element is a contaminant on a surface of the solid.

5. The method of claim 4, wherein the contaminant is a scale deposit.

6. The method of claim 1, wherein the metal, mineral, or element is calcium, magnesium, iron, copper, nickel, gold, silver, molybdenum, aluminum, lead, tungsten, chromium, cadmium, zinc, or arsenic.

7. The method of claim 1, wherein the chelating composition is contacted with the metal, mineral or element for a time period of about 1 minute to about 48 hours.

8. The method of claim 1, wherein the chelating composition further comprises a chemical surfactant, synthetic chelating agent, natural chelating agent, descaler, or scale inhibitor.

9. The method of claim 8, wherein the synthetic chelating agent is ethylenediaminetetraacetic acid (EDTA), nitrilotriacetic acid (NTA), phosphonate, succimer (DMSA), diethylenetriaminepentaacetate (DTPA), n-hydroxyethylethylenediaminetriacetic acid (HEDTA), organic acids with more than one coordination group (e.g., rubeanic acid), or N-acetylcysteine and the natural chelating agent is a carbohydrate, organic acid with more than one coordination group, lipid, steroid, amino acid or related compound, peptide, phosphate, nucleotide, tetrapyrrol, ferrioxamine, ionophore, phenolic, water, sodium gluconate, ethylenediamine disuccinic acid (EDDS), L-glutamic acid diacetic Acid (GLDA), methyl glycindiacetic acid (MGDA), polyaspartic acid (PASA), hemoglobin, chlorophyll, lipophilic β-diketone, (14,16)-hentriacontanedione, or any combination thereof.

10. The method of claim 8, wherein the scale remover or scale inhibitor is selected from the group consisting of polyphosphates, phosphate esters, phosphonates, polyacrylates, acetic acid, citric acid, formic acid, lactic acid, malic acid, oxalic acid, tartaric acid, uric acid, propionic acid, butyric acid, sorbic acid, fumaric acid, benzoic acid, hydrofluoric acid, caproic acid, salicylic acid, gluconic acid, pyruvic acid, adipic acid, trichloroacetic acid, glycolic acid, cinnamic acid, carboxylic acids, succinic acid, carbonic acid, glutaric acid, decanoic acid, ascorbic acid, hydrochloric acid, sulfuric acid, nitric acid, phosphoric acid, boric acid, perchloric acid, hydrofluoric acid, hydrobromic acid, and sulfonic acid.

11. The method of claim 1, wherein the method is at least one step of one of the following processes:
a) metal cleaning and surface preparation;
b) cleaning oil and gas well equipment;
c) synthesizing polymers;
d) pulp dying or bleaching;
e) textile cleaning, dying, or bleaching;
f) cleaning mining equipment;
h) treating metal poisoning;
i) increasing the shelf-life of personal care products, cleaning products, and food and beverages;
j) increasing solubility or availability of fertilizer components; or
k) water softening.

12. The method of claim 1, wherein the biosurfactant is a sophorolipid.

13. The method of claim 12, wherein the sophorolipid is a linear sophorolipid.

14. The method of claim 1, wherein the sequestering and/or dissolving comprises one or a combination of the following:
a) dissolving a sedimented or precipitated metal, mineral, or element;
b) neutralizing metal ions; or
c) preventing the agglomeration of metal ions.

15. A chelating composition comprising a sophorolipid biosurfactant and one or more substances capable of chelating metal and/or mineral ions, wherein the one or more substances capable of chelating metal and/or mineral ions are selected from the group consisting of EDTA, NTA, phosphonates, DMSA, DTPA, N-acetylcysteine, n-hydroxyethylethylenediaminetriacetic acid (HEDTA), organic acids with more than one coordination group (e.g., rubeanic acid), water, carbohydrates, organic acids with more than one coordination group, lipids, steroids, amino acids or related compounds, peptides, phosphates, nucleotides, tetrapyrrols, ferrioxamines, ionophores, phenolics, sodium gluconate, EDDS, GLDA, MGDA, PASA, hemoglobin, chlorophyll, lipophilic β-diketone, (14,16)-hentriacontanedione, and combinations thereof.

16. (canceled)

17. The composition of claim 15, wherein the composition is a cleaner, descaler, pharmaceutical, cosmetic, water softener, or fertilizer or an additive to a cleaner, descaler, pharmaceutical, cosmetic, water softener, or fertilizer.

18. The composition of claim 15, wherein the composition further comprises a non-biological surfactant.

19. A descaling composition comprising a linear sophorolipid and one or more scale removal or scale inhibiting substances, wherein the one or more scale removal or scale inhibiting substances are selected from the group consisting of polyphosphates, phosphate esters, phosphonates, polyacrylates, acetic acid, citric acid, formic acid, lactic acid, malic acid, oxalic acid, tartaric acid, uric acid, propionic acid, butyric acid, sorbic acid, fumaric acid, benzoic acid, hydrofluoric acid, caproic acid, salicylic acid, gluconic acid, pyruvic acid, adipic acid, trichloroacetic acid, glycolic acid, cinnamic acid, carboxylic acids, succinic acid, carbonic acid, glutaric acid, decanoic acid, ascorbic acid, hydrochloric acid, sulfuric acid, nitric acid, phosphoric acid, boric acid, perchloric acid, hydrofluoric acid, hydrobromic acid, and sulfonic acid.

20. (canceled)

21. The descaling composition of claim 19, comprising 1-02.0 ppm to 250 ppm of the linear sophorolipid.
